(19) United States
(12) Patent Application Publication
(10) Pub. No.: US 2009/0141826 A1
(43) Pub. Date: Jun. 4, 2009

(54) Digital signal transmitting system, receiving apparatus and receiving method

(76) Inventors: Toshinori Suzuki, Fujimino-shi (JP); Noriaki Miyazaki, Fujimino-shi (JP)

Correspondence Address: EDWARDS ANGELL PALMER & DODGE LLP, P.O. BOX 55874, BOSTON, MA, 02205, US

(21) Appl. No.: 11/921,276

(22) PCT Filed: May 30, 2006
(86) PCT No.: PCT/JP2006/310789

§ 371 Date: Nov. 29, 2007

(30) Foreign Application Priority Data
May 31, 2005 (JP) 2005-160328

(51) Int. Cl. H04L 27/00; H04L 27/06

(52) U.S. Cl. 375/295; 375/341

(57) ABSTRACT

A 4ASK demodulator (23) determines a received signal, based on both a received signal point at the time when a signal, which has been modulated by the 4ASK system, is received and a probability of occurrence of a modulated symbol of the 4ASK system.

### TECHNICAL FIELD

The present invention relates to a digital signal transmitting system, a receiving apparatus, and a receiving method.

Priority is claimed on Japanese Patent Application No. 2005-160328, filed May 31, 2005, the content of which is incorporated herein by reference.

### BACKGROUND ART

Recently, digital modulation is used in digital signal transmitting systems in a variety of fields, such as communications and broadcasting. There are various types of digital modulation, such as amplitude shift keying (ASK), phase shift keying (PSK), frequency shift keying (FSK), and quadrature amplitude modulation (QAM).

For example, in a four-value ASK (4ASK), there are two bits of data per modulated symbol. That is, there are four types of modulated symbols (‘00’, ‘01’, ‘10’, and ‘11’). Transport data is mapped every two bits to one of the modulated symbols corresponding to those two bits of data.

FIG. 11 is an example of a 4ASK signal point arrangement. In the example of FIG. 1, four signal points 101, 102, 103, and 104 are formed by combining a two-value signal amplitude with positive and negative polarities on an I-axis, and are made correspondent with the four types of modulated symbols ‘00’, ‘01’, ‘10’, and ‘11’. Signal point 101 corresponds to modulated symbol ‘00’, signal point 102 corresponds to modulation point ‘01’, signal point 103 corresponds to modulation point ‘10’, and signal point 104 corresponds to modulation point ‘11’.

When using the 4ASK shown in FIG. 11 in a conventional digital signal transmitting system, for example, a modulator provided in the transmitting apparatus sequentially creates one of the four signal points 101, 102, 103, and 104 from the data of every two bits of the transmission data. Specifically, of the two bits for modulation in the transmission data, the modulator determines the polarity of the signal point from the upper bit, and determines the signal amplitude from the lower bit.

A demodulator provided in the receiving apparatus determines a most likely signal point at modulation time based on the received signal point. This determination assumes that the occurrence probabilities of all the signal points, i.e. all the modulated symbols, are equal. Assuming that all the modulated symbols have equal occurrence probabilities, when, for example, a received signal point 201 shown in FIG. 12 is obtained, a signal point 102 which is closest to the received signal point 201 is deemed to be the most likely signal point at the time of modulation. Two bits of reception data ‘01’ from the modulated symbol ‘01’ corresponding to the signal point 102 are then output. Techniques relating to these conventional demodulators are described in, for example, Filippo Tosato, et al., ‘Simplified Soft-Output Demapper for Binary Interleaved COFDM with Application to HIPERLAN/2’, Communications, 2002.ICC 2002.IEEE International Conference on 28 Apr. 2002, vol. 2, process procedure performed by. 664-668 (see Equation (12) in FIG. 2), and Hiroyuki Kawai, et al., ‘Likelihood Function for QRM-MLD Suitable for Soft decision Turbo Decoding and its Performance for OFCDM MIMO Multiplexing in Multipath Fading Channel’, IEICE TRANS.COMMUN., VOL. E88-B, No. 1, January 2005, process procedure performed by. 47-57 (see FIG. 3).

However, while the conventional demodulator mentioned above determines, on the prior condition that all the modulated symbols have equal occurrence probabilities, that the signal point closest to the received signal point is the signal point of the most likely modulation time, and selects the most likely modulated symbol based on this determination result, since the occurrence probabilities of all the modulated symbols are not always steadily equal, there is thought to be room for improvement regarding this point.

### DISCLOSURE OF THE INVENTION

The present invention has been realized after consideration of these matters, and aims to provide a digital signal transmitting system that can increase reception reliability by considering the occurrence probabilities of modulated symbols, a receiving apparatus, and a receiving method.

To achieve the above objects, a digital signal transmitting system of the invention uses digital modulation having two or more bits of information per modulation symbol, and includes demodulating means that determines a transmitted signal based on a received signal point when the digitally modulated signal is received and an occurrence probability of a modulated symbol of the digital modulation.

In the digital signal transmitting system according to the invention, the occurrence probability is based on a reception processing result of the received signal.

In the digital signal transmitting system according to the invention, the occurrence probability is based on a likelihood of the reception processing result obtained in a reception process of the received signal.

A digital signal transmitting system according to the invention uses digital modulation having two or more bits of information per modulation symbol and a code for transmission; the digital signal transmitting system includes demodulating means that determines a transmitted signal based on a received signal point when the digitally modulated signal is received and an occurrence probability of a modulated symbol of the digital modulation, and decoding means that performs a decoding process to the code based on a demodulation result of the demodulating means, and feeds back a likelihood of the decoding result obtained in that decoding process as the occurrence probability.

A digital signal transmitting system of the invention uses digital modulation having two or more bits of information per modulation symbol and a code for transmission constituted by a plurality of element codes; the digital signal transmitting system includes demodulating means that determines a transmitted signal based on a received signal point when the digitally modulated signal is received and an occurrence probability of a modulated symbol of the digital modulation; and decoding means that includes decoders provided in correspondence with the element codes, the decoding means performing a decoding process by inputting a demodulation result of the demodulating means to the decoder, and outputting a likelihood of the demodulation result obtained in that decoding process as the occurrence probability.

In the digital signal transmitting system according to the invention, a demodulation result of the demodulating means reflecting a likelihood of a demodulation result of one of the decoders is used in another of the decoders.

In the digital signal transmitting system according to the invention, the code for transmission is a turbo code, and a priori value, an exterior value, or a value combining both a posterior value and an exterior value, is used as the likelihood of the decoding result.

The digital signal transmitting system according to the invention further includes means for determining the likelihood of a parity bit appended by the element code, from a decoding result corresponding to at least one element code or in a step of obtaining the decoding result, and means for updating a channel value by using the likelihood of the parity bit.

A receiving apparatus according to the invention receives a signal modulated by digital modulation having two or more bits of information per modulation symbol, and includes demodulating means that determines a transmitted signal based on a received signal point when the signal is received and an occurrence probability of a modulated symbol of the digital modulation.

In the receiving apparatus according to the invention, the occurrence probability is based on a reception processing result of the received signal.

In the receiving apparatus according to the invention, the occurrence probability is based on a likelihood of the reception processing result obtained in a reception process of the received signal.

A receiving apparatus of the invention receives a signal that has been subjected to digital modulation having two or more bits of information per modulation symbol, and coding using a code for transmission; the receiving apparatus includes demodulating means that determines a transmitted signal based on a received signal point when the digitally modulated signal is received and an occurrence probability of a modulated symbol of the digital modulation, and decoding means that performs a decoding process to the code based on a demodulation result of the demodulating means, and feeds backs a likelihood of the decoding result obtained in that decoding process as the occurrence probability.

A receiving apparatus of the invention receives a signal that has been subjected to digital modulation having two or more bits of information per modulation symbol, and coding using a code for transmission constituted by a plurality of element codes; the receiving apparatus includes demodulating means that determines a transmitted signal based on a received signal point when the digitally modulated signal is received and an occurrence probability of a modulated symbol of the digital modulation, and decoding means that includes decoders provided in correspondence with the element codes, the decoding means performing a decoding process by inputting a demodulation result of the demodulating means to the decoder, and outputting a likelihood of the demodulation result obtained in that decoding process as the occurrence probability.

In the receiving apparatus according to the invention, a demodulation result of the demodulating means reflecting a likelihood of a demodulation result of one of the decoders is used in another of the decoders.

In the receiving apparatus according to the invention, the code for transmission is a turbo code, and a priori value, an exterior value, or a value combining both a posterior value and an exterior value, is used as the likelihood of the decoding result.

The receiving apparatus according to the invention further includes means for determining the likelihood of a parity bit appended by the element code, from a decoding result corresponding to at least one element code or in a step of obtaining the decoding result, and means of updating a channel value by using the likelihood of the parity bit.

The invention also provides a receiving method that receives a signal modulated by digital modulation having two or more bits of information per modulation symbol, and includes a step of determining a transmitted signal based on a received signal point when the signal is received and an occurrence probability of a modulated symbol of the digital modulation.

In the receiving method according to the invention, the occurrence probability is based on a reception processing result of the received signal.

In the receiving method according to the invention, the occurrence probability is based on a likelihood of the reception processing result obtained in a reception process of the received signal.

A receiving method according to the invention receives a signal that has been subjected to digital modulation having two or more bits of information per modulation symbol, and coding using a code for transmission; the method includes a demodulating step of determining a transmitted signal based on a received signal point when the digitally modulated signal is received and an occurrence probability of a modulated symbol of the digital modulation, and a decoding step of performing a decoding process to the code based on a demodulation result of the demodulating means, and feeding backs a likelihood of the decoding result obtained in that decoding process as the occurrence probability.

A receiving method according to the invention receives a signal that has been subjected to digital modulation having two or more bits of information per modulation symbol, and coding using a code for transmission constituted by a plurality of element codes; the method includes a demodulating step of determining a transmitted signal based on a received signal point when the digitally modulated signal is received and an occurrence probability of a modulated symbol of the digital modulation, and a decoding step of performing a decoding process in correspondence with the element codes, performing the decoding process using a demodulation result of the demodulating step, and outputting a likelihood of the demodulation result obtained in that decoding process as the occurrence probability.

In the receiving method of the invention, a demodulation result of the demodulating step reflecting a likelihood of a demodulation result of one of the decoding processes is used in another of the decoding processes.

In the receiving method of the invention, the code for transmission is a turbo code, and a priori value, an exterior value, or a value combining both a posterior value and an exterior value, is used as the likelihood of the decoding result.

The receiving method of the invention further includes a step of determining the likelihood of a parity bit appended by the element code, from a decoding result corresponding to at least one element code or in a step of obtaining the decoding result, and a step of updating a channel value by using the likelihood of the parity bit.

The invention also provides a digital signal transmitting system using digital modulation having two or more bits of information per modulation symbol and a code for transmission, including demodulating means that determines a transmitted signal based on a received signal point when the signal is received and an occurrence probability of a modulated symbol of the digital modulation; and decoding means that performs a decoding process to the code based on a demodulation result of the demodulating means, and feeds backs a posterior value as the occurrence probability.

The invention also provides a digital signal transmitting system using digital modulation having two or more bits of information per modulation symbol and a code for transmission, including demodulating means that determines a transmitted signal based on a received signal point when the signal is received and an occurrence probability of a modulated symbol of the digital modulation, and decoding means that performs a decoding process to the code based on a demodulation result of the demodulating means, and feeds backs a likelihood of a decoding result obtained in that decoding process as the occurrence probability; the demodulating means deems that occurrence probabilities of all bits are equal at the time of a first demodulation of the received signal point, and uses an occurrence probability that is fed back from the decoding means at the time of second and subsequent demodulations of the same received signal point.

The invention also provides a digital signal transmitting system using digital modulation having two or more bits of information per modulation symbol and a code for transmission, including demodulating means that determines a transmitted signal based on a received signal point when the signal is received and an occurrence probability of a modulated symbol of the digital modulation, and decoding means that performs a decoding process to the code based on a demodulation result of the demodulating means, and feeds back a likelihood of a decoding result obtained in that decoding process as the occurrence probability; the decoding means deems that occurrence probabilities of all bits are equal at the time of a first demodulation of the received signal point, and uses a likelihood of a bit obtained in a decoding process at the time of subsequent demodulations and decodings of the same received signal point as the occurrence probability.

In the digital signal transmitting system according to the invention, an occurrence probability fed back to the demodulating means from the decoding means is a posterior value.

The invention also provides a receiving apparatus that receives a signal that has been subjected to digital modulation having two or more bits of information per modulation symbol, and coding using a code for transmission, including demodulating means that determines a transmitted signal based on a received signal point when the signal is received and an occurrence probability of a modulated symbol of the digital modulation, and decoding means that performs a decoding process of the code from the demodulation result of the demodulating means, and feeds back a posterior value as the occurrence probability.

The invention also provides a receiving apparatus that receives a signal that has been subjected to digital modulation having two or more bits of information per modulation symbol, and coding using a code for transmission, including demodulating means that determines a transmitted signal based on a received signal point when the signal is received and an occurrence probability of a modulated symbol of the digital modulation, and decoding means that performs a decoding process to the code based on a demodulation result of the demodulating means, and feeds backs a likelihood of a decoding result obtained in that decoding process as the occurrence probability; the demodulating means deems that occurrence probabilities of all bits are equal at the time of a first demodulation of the received signal point, and uses an occurrence probability that is fed back from the decoding means at the time of second and subsequent demodulations of the same received signal point.

The invention also provides a receiving apparatus that receives a signal that has been subjected to digital modulation having two or more bits of information per modulation symbol, and coding using a code for transmission that allows repeated decoding, including demodulating means that determines a transmitted signal based on a received signal point when the signal is received and an occurrence probability of a modulated symbol of the digital modulation, and decoding means that performs a decoding process to the code based on a demodulation result of the demodulating means, and feeds back a likelihood of a decoding result obtained in that decoding process as the occurrence probability; the demodulating means deems that occurrence probabilities of all bits are equal at the time of a first demodulation of the received signal point, and uses a bit likelihood, which is obtained in a decoding process in subsequent demodulations and decodings of the same received signal point, as an occurrence probability.

In the receiving apparatus according to the invention, the occurrence probability fed back from the decoding means to the demodulating means is a posterior value.

The invention also provides a receiving method of receiving a signal that has been subjected to digital modulation having two or more bits of information per modulation symbol, and coding using a code for transmission, the method including a demodulating step of determining a transmitted signal based on a received signal point when the signal is received and an occurrence probability of a modulated symbol of the digital modulation, and a decoding step of performing a decoding process of the code from the demodulation result of the demodulating means, and feeding back a posterior value as the occurrence probability.

The invention also provides a receiving method of receiving a signal that has been subjected to digital modulation having two or more bits of information per modulation symbol, and coding using a code for transmission, the method including a demodulating step of determining a transmitted signal based on a received signal point when the signal is received and an occurrence probability of a modulated symbol of the digital modulation, and a decoding step of performing a decoding process to the code based on a demodulation result of the demodulating means, and feeding back a likelihood of a decoding result obtained in that decoding process as the occurrence probability; the demodulating step deeming that occurrence probabilities of all bits are equal at the time of a first demodulation of the received signal point, and using an occurrence probability that is fed back from the decoding means at the time of second and subsequent demodulations of the same received signal point.

The invention also provides a receiving method of receiving a signal that has been subjected to digital modulation having two or more bits of information per modulation symbol, and coding using a code for transmission that allows repeated decoding, the method including a demodulating step of determining a transmitted signal based on a received signal point when the signal is received and an occurrence probability of a modulated symbol of the digital modulation, and a decoding step of performing a decoding process to the code based on a demodulation result of the demodulating means, and feeding back a likelihood of a decoding result obtained in that decoding process as the occurrence probability; the demodulating step deeming that occurrence probabilities of all bits are equal at the time of a first demodulation of the received signal point, and using a bit likelihood, which is obtained in a decoding process in subsequent demodulations and decodings of the same received signal point, as an occurrence probability.

In the receiving method according to the invention, the occurrence probability fed back from the decoding step to the demodulating step is a posterior value.

According to the invention, at the time of digital modulation, in addition to the positional relationship between a signal point corresponding to the modulated symbol and a received signal point, the occurrence probability of the modulated symbol can also considered is determining the transmitted signal. Therefore, reception performance can be enhanced.

### BRIEF DESCRIPTION OF THE DRAWINGS

FIG. 1 is a block diagram of a configuration of a digital signal transmitting system according to an embodiment of the invention.

FIG. 2 is a block diagram of an example configuration of a digital signal transmitting system according to Example 1 of the invention.

FIG. 3 is a block diagram of an example configuration of a turbo coder 31.

FIG. 4 is an example of an 8ASK signal point arrangement.

FIG. 5 is a block diagram of a characteristic configuration according to Example 1 of the invention.

FIG. 6 is a block diagram of a characteristic configuration according to Example 2 of the invention.

FIG. 7 is a block diagram of a characteristic configuration according to Example 3 of the invention.

FIG. 8 is a graph of simulation results according to the invention.

FIG. 9 is a block diagram of a configuration according to Example 5 of the digital signal transmitting system of the invention.

FIG. 10 is a block diagram of a characteristic configuration according to Example 5 of the invention.

FIG. 11 an example of a 4ASK signal point arrangement.

FIG. 12 is an example of a received signal point.

FIG. 13 is a block diagram of a configuration according to Example 6 of the digital signal transmitting system of the invention.

FIG. 14 is a block diagram of a characteristic configuration according to Example 6 of the invention.

FIG. 15 is a block diagram of a characteristic configuration according to Example 7 of the invention.

FIG. 16 is a block diagram of a configuration according to Example 8 of the digital signal transmitting system of the invention.

FIG. 17 is a block diagram of a characteristic configuration according to Example 8 of the invention.

### REFERENCE NUMERALS

20, 40, 70, 401, 701 . . . Receiving apparatuses,
22, 42, 72 . . . Wireless receivers,
23, 73 . . . 4ASK demodulators,
24 . . . Occurrence probability calculators,
43, 47 . . . 8ASK demodulators,
44, 441 . . . Turbo decoders,
45, 75 . . . Bit deciding units,
46 . . . Reverse-interleaver,
74 . . . LDPC decoder,
410, 411, 420, 421 . . . Switches.

### BEST MODE FOR CARRYING OUT THE INVENTION

An illustrative embodiment of the invention will be explained with reference to the drawings.

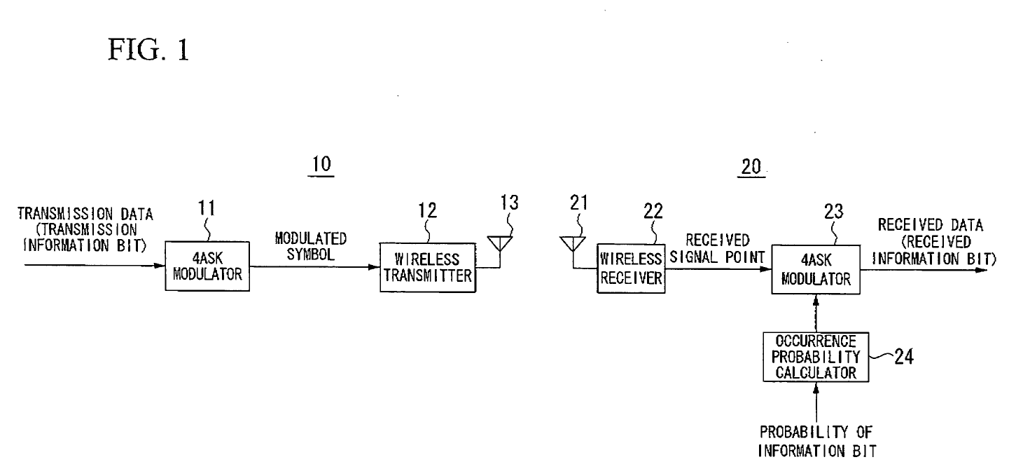

FIG. 1 is a block diagram of a configuration of a digital signal transmitting system according to an embodiment of the invention. This embodiment describes an example applied in a wireless communication system. In the system of FIG. 1, a 4ASK is used as an example of a digital modulating method, and the signal point arrangement shown in the example of FIG. 11 is used for convenience.

The wireless communication system shown in FIG. 1 includes a transmitting apparatus 10 and a receiving apparatus 20.

In FIG. 1, the transmitting apparatus 10 includes a 4ASK modulator 11, a wireless transmitter 12, and an antenna 13. Transmission data is input as serial data (transmission information bits) to the 4ASK modulator 11.

For every two bits of transmission data, the 4ASK modulator 11 creates one of four signal points 101, 102, 103, and 104 (see FIG. 11) from those two bits, and outputs a corresponding modulated symbol to the created signal point. Signal point 101 corresponds to modulated symbol ‘00’, signal point 102 corresponds to modulated symbol ‘01’, signal point 103 corresponds to modulated symbol ‘10’, and signal point 104 corresponds to modulated symbol ‘11’. The wireless transmitter 12 transmits the modulated symbol output by the 4ASK modulator 11 from the antenna 13.

In FIG. 1, the receiving apparatus 20 includes an antenna 21, a wireless receiver 22, a 4ASK demodulator 23, and an occurrence probability calculator 24. A signal which is transmitted from the transmitting apparatus 10 passes through the antenna 21 at the receiving apparatus 20, and is received by the wireless receiver 22. The received signal point is output from the wireless receiver 22 and input to the 4ASK demodulator 23. Occurrence probabilities of the modulated symbols are input to the 4ASK demodulator 23 from the occurrence probability calculator 24.

The 4ASK demodulator 23 determines a signal transmitted from the transmitting apparatus 10 based on the received signal point and the modulated symbol. Two bits of received data (received information bits) are output based on this determination result.

A probability (probability of information bit) of each of the two bits of data of the modulated symbol is input to the occurrence probability calculator 24. The probability of each information bit is calculated by obtaining similar reception data from past reception data. The occurrence probability calculator 24 calculates the occurrence probability of each modulated symbol based on the probabilities of the information bits.

Generally, if the probability that the upper bit will be ‘0’ is expressed as Pmsb (the probability that the upper bit will be ‘1’ becomes [1−Pmsb]) and the probability that the lower bit will be ‘0’ is expressed as Plsb (the probability that the lower bit will be ‘1’ becomes [1−Plsb]), the occurrence probability Pxy of a modulated symbol ‘xy’ is calculated using Pmsb and Plsb.

For example, when there is a 100% probability that the upper bit of the modulated symbol will be ‘1’, the occurrence probability calculator 24 calculates 50% occurrence probabilities for modulated symbols ‘10’ and ‘11’, and calculates 0% occurrence probabilities for modulated symbols ‘00’ and ‘01’.

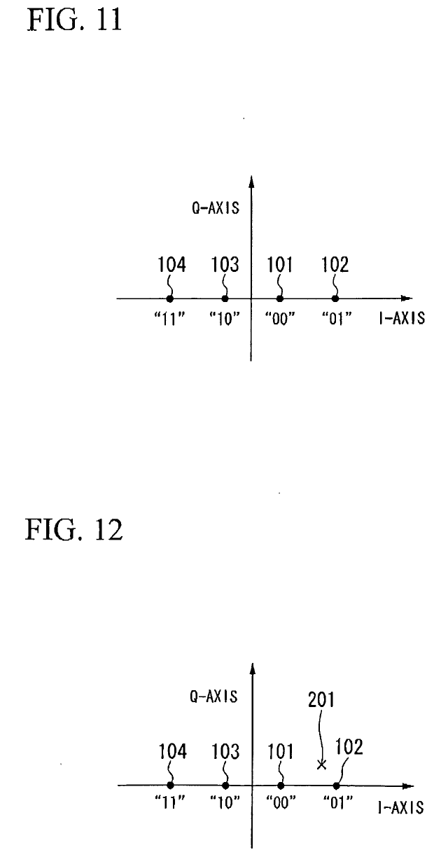

In this example of modulated symbol occurrence probabilities, for example, when the received signal point 201 shown in FIG. 12 is obtained, since the occurrence probabilities of modulated symbols ‘00’ and ‘01’ are both 0%, the 4ASK demodulator 23 excludes them from the selection candidates. From the remaining modulated symbols ‘10’ and ‘11’, the 4ASK demodulator 23 selects the likeliest modulated symbol based on its occurrence probability and received signal point. Since the occurrence probabilities of modulated symbols ‘10’ and ‘11’ are both 50%, the 4ASK demodulator 23 selects modulated symbol ‘10’ corresponding to signal point 103 which is closest to the received signal point 201, and outputs two bits ‘10’ of received data.

A method of determining a modulated symbol at the time of demodulation in this embodiment will be explained in greater detail.

In this embodiment, the occurrence probability calculator 24 provides occurrence probabilities P00, P01, P10, and P11 for each of the four types of modulated symbols ‘00’, ‘01’, ‘10’, and ‘11’ in the 4ASK.

From the received signal points and the occurrence probabilities P00, P01, P10, and P11 of the modulated symbols, the 4ASK demodulator 23 determines the most likely signal point of the transmitting apparatus 10 at the time of modulation. Two bits of received data (received information bits) are output from the modulated symbol corresponding to the signal point thereby determined.

More specifically, the 4ASK demodulator 23 calculates square distances d00, d01, d10, and d11 between the received signal points and the signal points corresponding to the modulated symbols. Next, it calculates posterior probabilities Q00, Q01, Q10, and Q11 from values obtained by dividing the square distances d00, d01, d10, and d11 by noise power dispersion σ2. Using the four occurrence probabilities P00, P01, P10, and P11 and the posterior probabilities Q00, Q01, Q10, and Q11, the 4ASK demodulator 23 determines which of the values P00×Q00, P01×Q01, P10×Q10, and P11×Q11 has the highest probability, and selects the modulated symbol corresponding to this determination result.

According to this embodiment, when demodulating a digital modulation, in addition to the positional relationship between a received signal point and a signal point corresponding to the modulated symbol, the occurrence probability of the modulated symbol can also be considered in determining a signal transmitted from the transmitting apparatus 10. This can increase the reception capability.

In the receiving apparatus 20, if an error correcting decoder is provided in the later stage of the output of the 4ASK demodulator 23, the output of the 4ASK demodulator 23 can be obtained as a soft decision output. In this case, the probability that the upper bit will be ‘0’ is output as [P00×Q00+P01×Q01], and the probability that the lower bit will be ‘0’ is output as [P00×Q00+P10×Q10]. Alternatively, the probability that the upper bit will be ‘0’ can be output approximately as [Max (P00×Q00+P01×Q01)], and the probability that the lower bit will be ‘0’ can be output approximately as [Max (P00×Q00+P10×Q10)].

When the probabilities are approximate, the probability Qxy can be determined without considering noise power dispersion σ2, by calculating only the square distances between the received signal points and the signal points corresponding to the modulated symbols.

Also, log likelihoods of the information bits can be input as data to the occurrence probability calculator 24.

While the embodiment described above uses 4ASK as one type of ASK, this is not limitative of the digital modulating method of this invention, and a digital modulating method having more than two bits of data per modulated symbol can be used instead. For example, it is also applicable when using PSK and QAM. Furthermore, similar effects can be achieved by applying either a single-carrier modulating method or a multi-carrier modulating method in the invention. Similar effects can also be achieved when a multi input multi output (MIMO) transmitting method that uses a plurality of transmitting/receiving antennas is applied in the invention.

### EXAMPLE 1

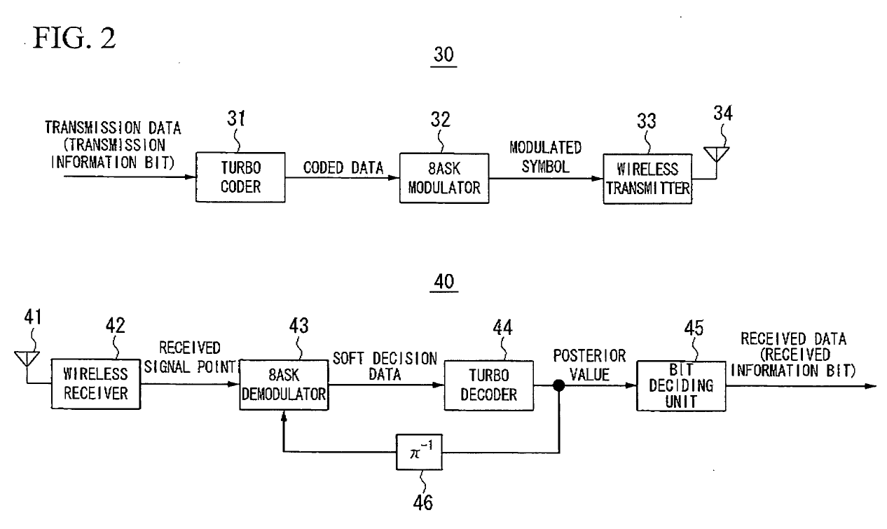

FIG. 2 is an example of a digital signal transmitting system according to the invention.

In Example 1, the invention is applied in a wireless communication system using turbo codes, and the likelihoods of the decoded results of the turbo codes are used as occurrence probabilities of the modulated symbols. The system of FIG. 2 uses 8ASK (an eight-value ASK) as one example of a digital modulating method.

The wireless communication system shown in FIG. 2 includes a transmitting apparatus 30 and a receiving apparatus 40.

In FIG. 2, the transmitting apparatus 30 includes a turbo encoder 31, an 8ASK modulator 32, a wireless transmitter 33, and an antenna 34. Transmission data is input as serial data (transmission information bits) to the turbo encoder 31.

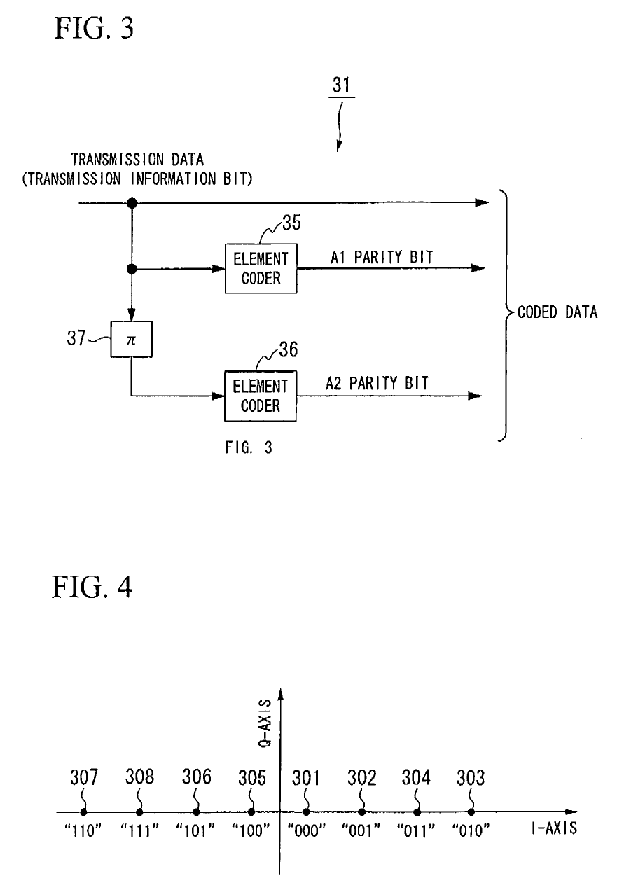

FIG. 3 is an example of a configuration of the turbo encoder 31. The configuration of FIG. 3 is a conventional one. The turbo encoder 31 of FIG. 3 includes two constituent encoders 35 and 36, and uses two constituent codes for encoding.

In FIG. 3, the constituent encoder 35 creates a parity bit a1 from a transmission information bit. An interleaver 37 interleaves the sequence of the input transmission information bits. The constituent encoder 36 creates a parity bits a2 from the transmission information bit after it is output from the interleaver 37. Thus two parity bits a1 and a2 are created from the same transmission information bit. However, the input sequences of the transmission information bits at the constituent encoders 35 and 36 are interleaved.

The turbo encoder 31 outputs the input transmission information bit, parity bit a1, and parity bit a2 (a total of three bits) as encoded data.

Referring back to FIG. 2, the 8ASK modulator 32 maps the encoded three-bit data to a modulated symbol having three bits of data.

FIG. 4 is an example of an 8ASK signal point arrangement. In the example of FIG. 4, eight signal points 301 to 308 are formed by combining a four-value signal amplitude with positive and negative polarities on an I-axis, and are made correspondent with four types of modulated symbols ‘000’, ‘001’, ‘010’, . . . , and ‘111’. Gray encoding is used to obtain a humming distance of 1 between adjacent signal points.

For sake of convenience in Example 1, during encoding, if the transmission information bit is expressed as ‘x’, parity bit a1 as ‘p1’, and parity bit a2 as ‘p2’, the 8ASK modulator 32 maps them such that the three bits of the modulated symbol become ‘x p1 p2’. That is, the transmission information bit is mapped to the uppermost bit of the modulated symbol, the parity bit a1 is mapped to the middle bit, and the parity bit a2 is mapped to the lowermost bit.

The wireless transmitter 33 transmits the modulated symbol after it is output from the 8ASK modulator 32 from the antenna 34.

In FIG. 2, the receiving apparatus 40 includes an antenna 41, a wireless receiver 42, an 8ASK demodulator 43, a turbo decoder 44, a bit deciding unit 45, and a reverse interleaver 46. The signal that is transmitted from the transmitting apparatus 30 passes via the antenna 41 of the receiving apparatus 40 and is received at the wireless receiver 42. The received signal point is output from the wireless receiver 42 and input to the 8ASK demodulator 43.

A posterior value which is output from the turbo decoder 44 is input to the 8ASK demodulator 43 after being reverse-interleaved by the reverse interleaver 46. Based on the received signal point and the posterior value output from the reverse interleaver 46, the 8ASK demodulator 43 makes a soft decision regarding the likeliest modulated symbol, and outputs a soft decision value for each bit of the modulated symbol as soft decision data. The soft decision data is input to the turbo decoder 44 as a channel value.

The posterior value which is output from the turbo decoder 44 is the likelihood of the decoded result obtained by the turbo decoder 44, and is used as the occurrence probability of the modulated symbol. To achieve this, the posterior value output from the turbo decoder 44 is fed back to the 8ASK demodulator 43 via the reverse interleaver 46.

The turbo decoder 44 performs a decoding process to the channel value, and outputs a posterior value. The bit deciding unit 45 makes a bit determination regarding the posterior value, and outputs received data (received information bit).

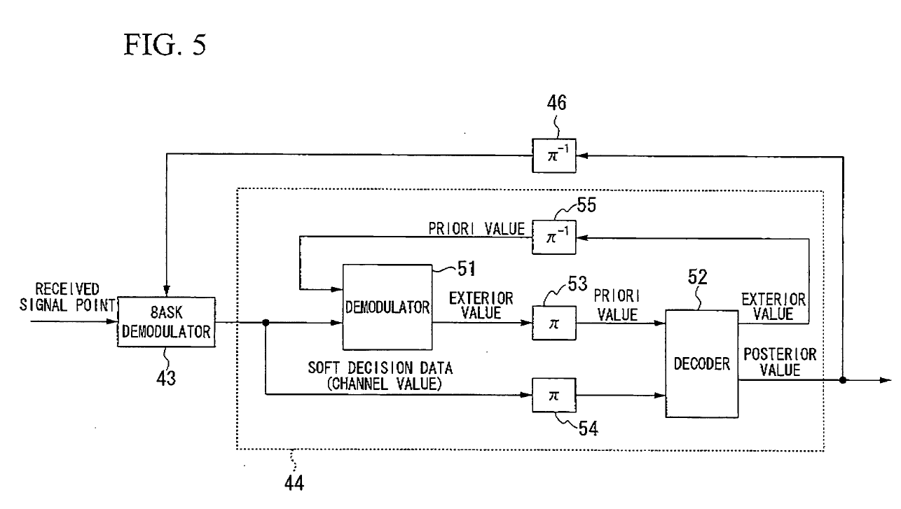

FIG. 5 is a configuration of the turbo decoder 44 and a characteristic configuration of Example 1. A characteristic operation of Example I will be explained in detail while referring to FIG. 5.

The 8ASK demodulator 43 outputs a soft decision value of each bit of the modulated symbol as soft decision data. This soft decision data is input as a channel value to the turbo decoder 44. For sake of convenience in Example 1 described above, the transmission information bit is mapped to the uppermost bit of the modulated symbol, parity bit a1 is mapped to the middle bit, and parity bit a2 is mapped to the lowermost bit. Therefore, of the three bits of the channel value, the uppermost bit is a channel value of the transmission information bit, the middle bit is a channel value of parity bit a1, and the lowermost bit is a channel value of the parity bit a2.

The configuration of the turbo decoder 44 shown in FIG. 5 corresponds to that of the turbo encoder 31 shown in FIG. 3, and includes a decoder 51 corresponding to the constituent encoder 35, and a decoder 52 corresponding to the constituent encoder 36. Incidentally, the configuration of the turbo decoder 44 in FIG. 5 is a conventional one.

At the turbo decoder 44, firstly, the decoder 51 inputs the channel values of the transmission information bit and the parity bit a1. In an initial decoding process of the decoder 51, the posterior value of the transmission information bit is set at [½] (log likelihood zero). An exterior value and a posterior value of the transmission information bit are thereby calculated. Generally in this stage, only the exterior value is used in a next process.

After being output from the decoder 51, the exterior value is interleaved by an interleaver 53 and input as a posterior value to the decoder 52. Channel values of the transmission information bit and the parity bit a2 are input to the decoder 52. As with the exterior value output from the decoder 51, the channel value of the transmission information bit is interleaved by an interleaver 54 before being input to the decoder 52.

The decoder 52 outputs the exterior value and the posterior value of the transmission information bit as a decoding process result. The posterior value output from the decoder 52 is reverse-interleaved by the reverse interleaver 46, and input to the 8ASK demodulator 43 as an occurrence probability of the modulated symbol. The exterior value output from the decoder 52 is reverse-interleaved by a reverse interleaver 55, and input as a priori value to the decoder 51. Thus, while a second arithmetical process is executed by the decoder 51, the soft decision data (channel value) used in the second process is updated by the 8ASK demodulator 43 such as to reflect the occurrence probability of the modulated symbol, and can consequently be expected to be more precise than the previous soft decision data (channel path) of the first process. Therefore, by using this procedure to repeat the series of arithmetic operations, error correction performance can be increased and transmission errors can be further prevented.

While the turbo encoder 31 in Example 1 outputs the parity bits as they are, they can be modified in various ways, such as puncturing the parity bits, channel-interleaving the transmission information bit and the parity bits, and so on. The configuration of the turbo decoder 44 can be changed to accommodate such modifications.

### EXAMPLE 2

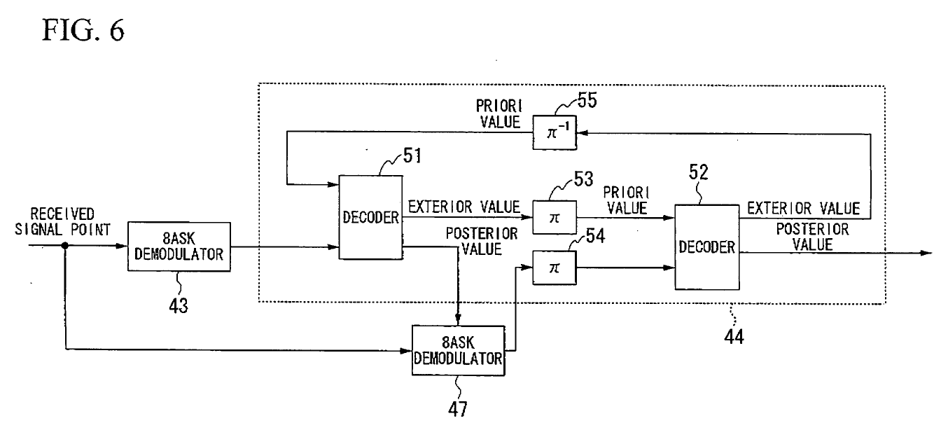

FIG. 6 is a block diagram of a characteristic configuration according to Example 2, relating to the wireless communication system of Example 1 shown in FIG. 2 and illustrating sections relating to 8ASK demodulation and turbo encoding.

In Example 2, as shown in FIG. 6, an 8ASK demodulator 47 is added. The 8ASK demodulator 47 uses posterior values output from the decoder 51 as the occurrence probabilities of the modulated symbols. In Example 2, the reverse interleaver 46 for feeding back the posterior value output from the decoder 52 to the 8ASK demodulator 43 is not provided.

The 8ASK demodulator 47 uses the posterior value output from the decoder 51 to update the channel value for input to the decoder 52. This updating process is similar to that of the 4ASK demodulator 23 mentioned above, in that the channel value is updated based on the posterior probability of each information bit. Thus in Example 2, the channel value passed to the decoder 52 can be updated using the likelihood of the transmission information bit obtained by the decoder 51, whereby the precision of the channel value input to the decoder 52 can be increased.

Instead of the posterior probability, the exterior probability or a value incorporating both posterior and exterior values (e.g. an average value) can be used as the probability of the information bit, enabling similar effects to be obtained.

### EXAMPLE 3

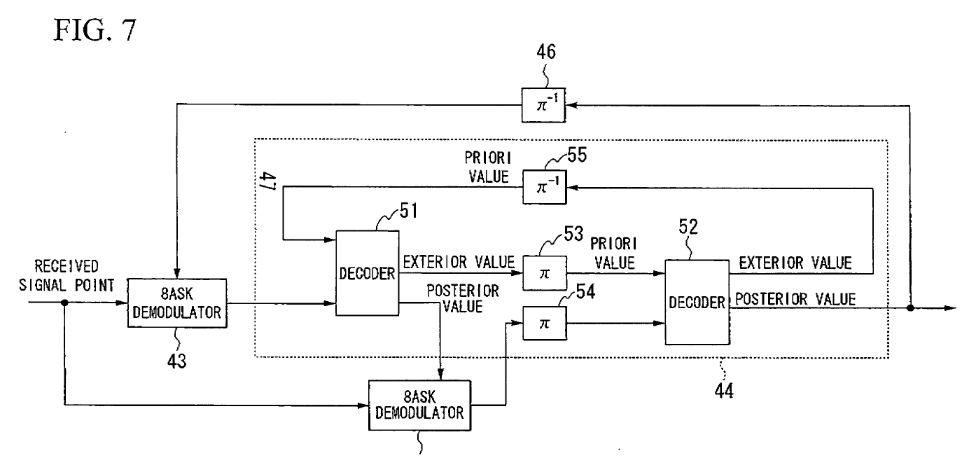

FIG. 7 is a block diagram of a characteristic configuration according to Example 3, relating to the wireless communication system of Example 1 shown in FIG. 2 and illustrating sections relating to 8ASK demodulation and turbo decoding.

Example 3 is a configuration which combines Examples 1 and 2 described above, and includes a reverse interleaver 46 and an 8ASK demodulator 47. According to Example 3, the decoder 51 and the decoder 52 can alternately update the channel value, thereby further enhancing performance.

In Examples 1 to 3 described above, the channel value is corrected using the priori value of a codeword obtained in the decoding process of a turbo code, and the result is input to the subsequent arithmetic calculation. Since this increases the precision of the channel value in each decoding process, the decoding capability of turbo codes is increased.

### EXAMPLE 4

Example 4 is an additional modification of Examples 1 and 3, in which the channel value is made more precise by determining prior probabilities of parity bits a1 and a2.

Generally in turbo encoding, although the decoder 51 and the decoder 52 determine the likelihood of the transmission information bit, the likelihoods of the parity bits a1 and a2 are not output. The two methods described below are examples of methods for determining the likelihoods of the parity bits a1 and a2.

One method uses an element encoder to encode the log likelihood of the transmission information bit. The element encoder used here internally performs a real number calculation, and can treat the parity signal that is output as the log likelihood of the parity bit.

Another method adds internal calculations of the decoders 51 and 52 in determining the likelihoods of the parity bits a1 and a2. An algorithm used by the decoders 51 and 52 (log-MAP and Max-log-MAP are representative algorithms) uses a backward state probability βₙ, of time n and a branch metric γₙ of time n to determine all probability sums when the parity bits a1 and a2 are ‘0’. Alternatively, if the item having the highest probability is selected without determining the probability sum, this will give approximate likelihoods of parity bits a1 and a2. Thus the likelihoods of the parity bits a1 and a2 are determined.

Using such methods, for example in Example 3, the decoder 51 can use the likelihoods of the transmission information bit and the parity bit a1 in updating the channel values transmission information bit and the parity bit a2, before inputting them to the decoder 52. The decoder 52 can use the likelihoods of the transmission information bit and the parity bit a2 in updating the likelihoods of the transmission information bit and the parity bit a1, before inputting them to the decoder 51.

By providing decoders corresponding to each of the plurality of element codes in this way, the likelihoods of the parity bits and the transmission information bit output from each decoder can be used in increasing the precision of the channel path passed to the next decoder, further reducing transmission errors.

While log-MAP and Max-log-MAP are representative decoding algorithms used by decoders, the invention is not limited to them, and various types of decoding algorithms can be applied.

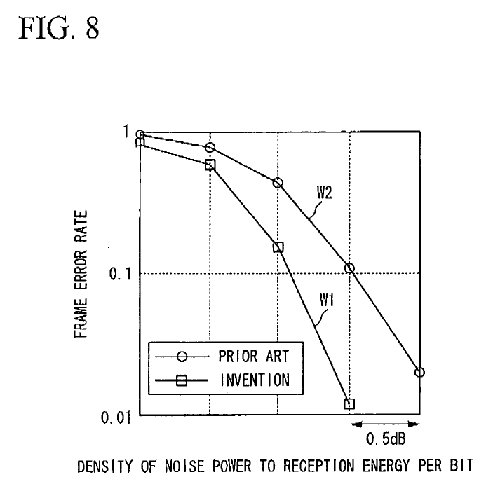

FIG. 8 is a graph of a simulation result according to the invention.

In FIG. 8, the vertical axis represents a frame error rate, and the horizontal axis represents the density of noise power to reception energy per bit. Waveform W1 expresses a simulation result of Example 4 of the invention, and waveform W2 expresses a simulation result of an 8ASK demodulator and a turbo demodulator in a conventional configuration. Max-log-MAP is used as the decoding algorithm.

As is clear from FIG. 8, the invention has a lower transmission error rate than the conventional configuration. This indicates that the same transmission error rate can be achieved with less reception energy, and that the invention increases reception performance.

### EXAMPLE 5

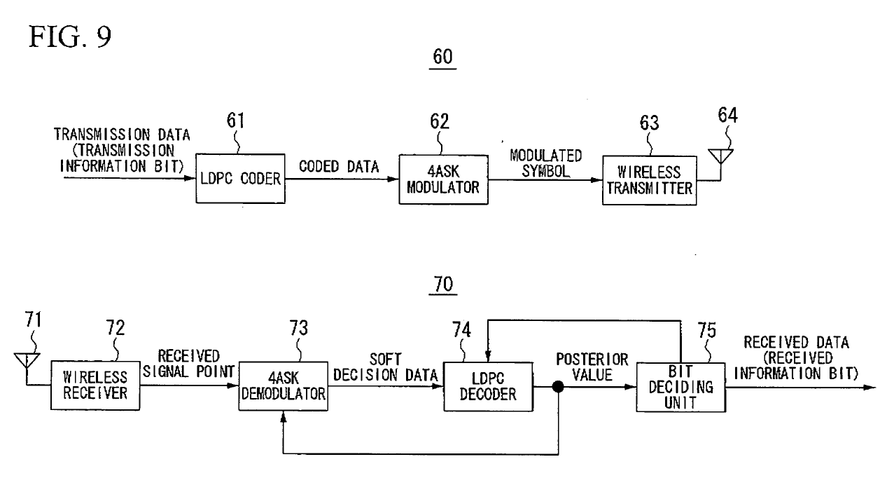

FIG. 9 is another example of a digital signal transmitting system according to the invention.

In Example 5, the invention is applied in a wireless communication system which corrects errors using low-density parity-check code (LDPC), where the likelihood of decoded results of LDPC codes are used as the occurrence probabilities of modulated symbols. The system of FIG. 9 uses 4ASK as one example of a digital modulating method.

The wireless communication system shown in FIG. 9 includes a transmitting apparatus 60 and a receiving apparatus 70.

In FIG. 9, the transmitting apparatus 60 includes an LDPC encoder 61, a 4ASK demodulator 62, a wireless transmitter 63, and an antenna 64.

Transmission data is input as serial data (transmission information bit) to the LDPC encoder 61. Encoded data output from the LDPC encoder 61 is mapped to the modulated symbol by the 4ASK demodulator 62, and transmitted by the wireless transmitter 63 from the antenna 64.

In FIG. 9, the receiving apparatus 70 includes an antenna 71, a wireless receiver 72, a 4ASK demodulator 73, an LDPC decoder 74, and a bit deciding unit 75. A signal which is transmitted from the transmitting apparatus 60 is received via the antenna 71 at the wireless receiver 72 of the receiving apparatus 70. The received signal point is output from the wireless receiver 72, and input to the 4ASK demodulator 73.

A posterior value which is output from the LDPC decoder 74 is input to the 4ASK demodulator 73. The 4ASK demodulator 73 makes a soft decision regarding the most likely modulated symbol, based on the posterior value and the received signal point which are fed back to it, and outputs a soft decision value for each bit of the modulated symbol as soft decision data. The soft decision data is input to the LDPC decoder 74 as a channel value. The posterior value which is output from the LDPC decoder 74 is the likelihood of the decoded result obtained by the LDPC decoder 74, and is used as the occurrence probability of the modulated symbol. To achieve this, the posterior value output from the LDPC decoder 74 is fed back to the 4ASK demodulator 73.

The LDPC decoder 74 performs a decoding process to the channel value, and outputs a posterior value. The bit deciding unit 75 makes a bit determination regarding the posterior value, and outputs received data (received information bit). The determination result of the bit deciding unit 75 is fed back to the LDPC decoder 74.

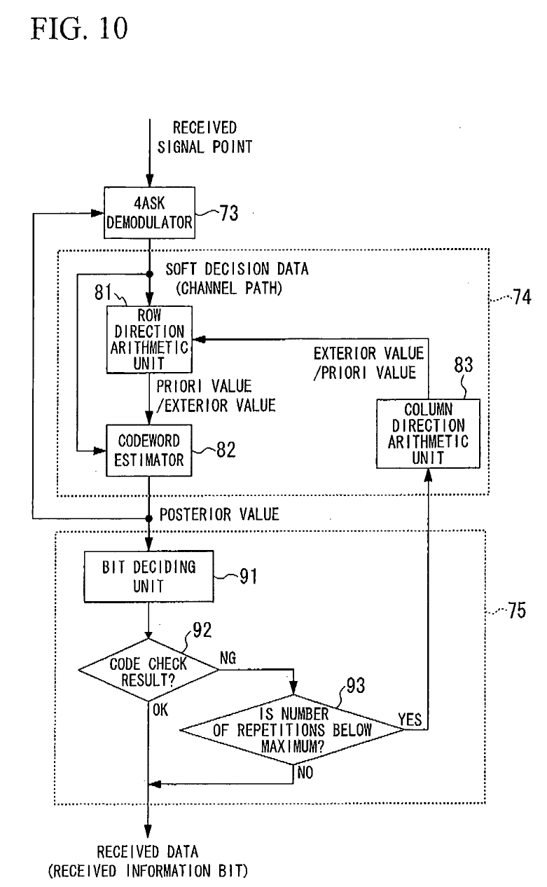

FIG. 10 is a block diagram of a characteristic configuration according to Example 5. FIG. 10 illustrates the configurations of the LDPC decoder 74 and the bit deciding unit 75, and a characteristic configuration of Example 5. A characteristic operation according to Example 5 will be explained with reference to FIG. 10.

The 4ASK demodulator 73 outputs soft decision value of each bit of the modulated symbol as soft decision data. This soft decision data is input to the LDPC decoder 74 as a channel value.

The LDPC decoder 74 shown in FIG. 10 includes a row direction arithmetic unit 81, a codeword estimator 82, and a column direction arithmetic unit 83. The LDPC decoder 74 in FIG. 10 has a conventional configuration.

The LDPC decoder 74 repeatedly calculates posterior values in similar manner to the turbo encoding described earlier. Representative decoding algorithms for this are Min Sum and Sum Product. Calculation is repeated until the decoded result becomes the correct codeword, or until a stipulated number of repetitions is reached.

At the LDPC decoder 74, firstly, the row direction arithmetic unit 81 performs a row direction arithmetic operation to the input channel value, and outputs a posterior value (or an exterior value). In performing this row direction arithmetic operation, it refers to an exterior value (or a posterior value) input from the column direction arithmetic unit 83. The codeword estimator 82 makes a codeword estimation based on the channel value output from the 4ASK demodulator 73 and the posterior value (or exterior value) output from the row direction arithmetic unit 81, and outputs the posterior value. The column direction arithmetic unit 83 performs a column direction arithmetic operation based on the determination result input from the bit deciding unit 75, and outputs an exterior value (or a posterior value).

The bit deciding unit 75 shown in FIG. 10 includes a bit deciding unit 91, a code detector 92, and a maximum number of repetitions deciding unit 93. The bit deciding unit 75 of FIG. 10 has a conventional configuration.

In the bit deciding unit 75, firstly, the bit deciding unit 91 makes a bit determination based on the input posterior value. From this bit determination result, the code checker 92 determines whether the result of a code check is Pass or Fail. If the code check result is Pass, the result of that bit determination is output as received data (received information bit). On the other hand, if the code result is Fail, the maximum number of repetitions deciding unit 93 determines whether the number of repetitions in the LDPC decoder 74 has reached the maximum number of repetitions. If it reaches the maximum number of repetitions, the result of this bit determination is output as received data (received information bit). If it has not reached the maximum number of repetitions, the LDPC decoder 74 is commanded to repeat the calculation.

According to Example 5 described above, as in Example 1, the channel path value is corrected using the posterior value of a codeword obtained in a process of decoding an LDPC code, and the result is fed back to the next decoding operation. In a conventional LDPC decoding process, the channel value does not change while repeating the calculation. In contrast in Example 5, the channel value is updated every time the calculation is repeated, thereby increasing its precision and enhancing the error correction capability.

While in Example 5, soft decision data (channel value) is updated once per repeated decoding operation, the channel value can be updated a plurality of times, as in Example 3. In this case, for example, the channel value is updated twice, based on the probability following the row direction arithmetic operation and the column direction arithmetic operation.

The posterior value of the codeword obtained in the process of decoding the LDPC code generally includes a transmission information bit and a parity bit. Therefore, there is no particular need to calculate the likelihood of the parity bit in the manner of Example 4.

### EXAMPLE 6

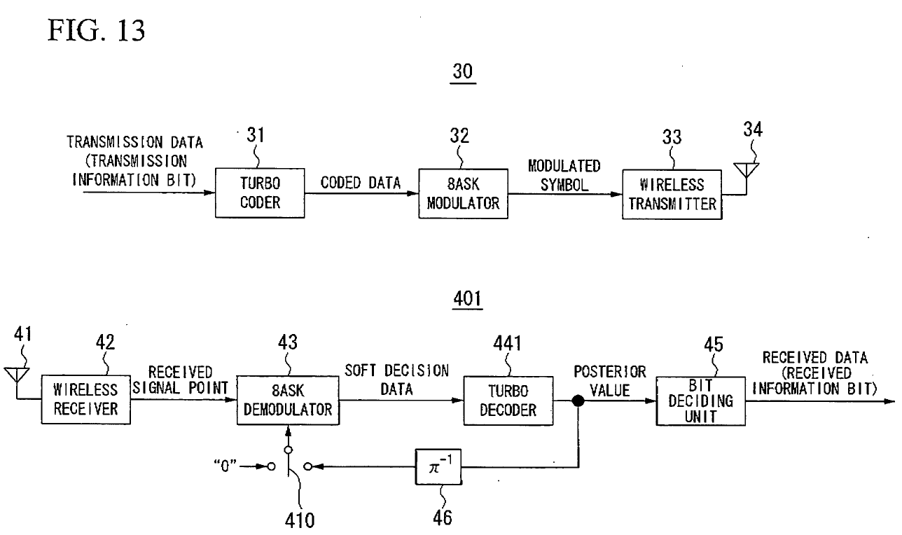

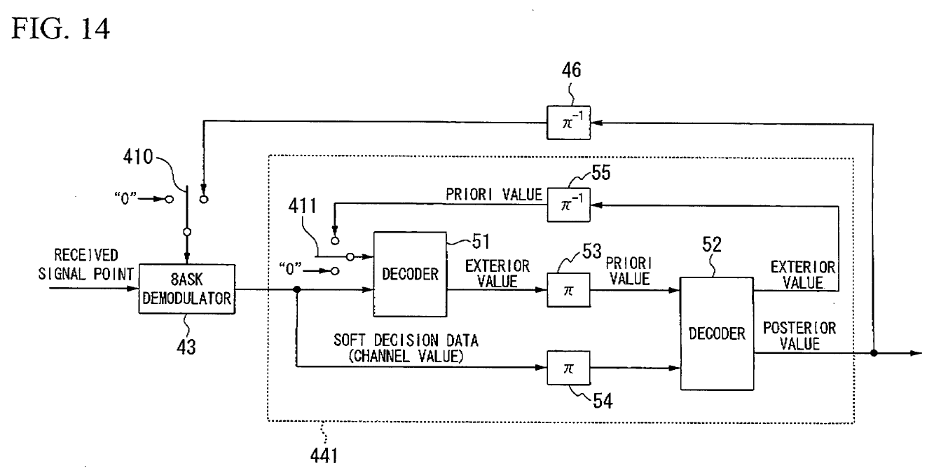

FIGS. 13 and 14 illustrate a sixth example.

FIG. 13 is a sixth example of digital signal transmitting system according to the invention. Example 6 is a modification of Example 1 shown in FIG. 2, wherein the receiving apparatus 40 of FIG. 2 is replaced by a receiving apparatus 401. The transmitting apparatus 30 is the same as that in Example 1.

In the receiving apparatus 401 shown in FIG. 13, @[the turbo decoder 44 of FIG. 2] is replaced by a turbo decoder 441. A switch 410 is provided between the reverse interleaver 46 and the 8ASK demodulator 43. In the receiving apparatus 401, the modifications to the receiving apparatus 40 of FIG. 2 are the portions relating to the turbo decoder 441 and the switch 410, the other parts being the same as the receiving apparatus 40 of FIG. 2. Only the modifications to the receiving apparatus 40 of FIG. 2 will be explained below.

In FIG. 13, the switch 410 switches the signal for input to the 8ASK demodulator 43 to an output signal of the reverse interleaver 46 (the signal obtained when the posterior value that constitutes the output of the turbo decoder 44 has been reverse-interleaved by the reverse interleaver 46), or to a signal ‘0’. The signal ‘0’ is a log likelihood ‘0’ corresponding to the posterior value [½], and indicates that the posterior values (occurrence probabilities) of all the bits are equal.

A switching operation of the switch 410 will be explained. A received signal point is input from the wireless receiver 42 to the 8ASK demodulator 43, and signal ‘0’ is used as the occurrence probability in a first demodulation for this input received signal point. The reason for this is that no posterior value has been calculated for a received signal point which is being decoding for the first time. Therefore, at the time of the first demodulation for a given received signal point, the switch 410 connects the signal ‘0’ to the 8ASK demodulator 43.

In second and subsequent demodulations of the received signal point, a signal obtained after the posterior value output from the turbo decoder 441 has been reverse-interleaved by the reverse interleaver 46 is used as the occurrence probability. Therefore, in second and subsequent decodings for a given received signal point, the switch 410 connects the signal output by the reverse interleaver 46 to the 8ASK demodulator 43.

FIG. 14 is a configuration of the turbo decoder 441 and a characteristic configuration of Example 6. In the turbo decoder 441 shown in FIG. 14, a switch 411 is provided between the reverse interleaver 55 and the decoder 51. In the turbo decoder 441, the modification to the turbo decoder 44 of FIG. 5 is the portion relating to the switch 411, the other parts being the same as the receiving apparatus 40 of FIG. 2. Only the modifications to the turbo decoder 44 of FIG. 5 will be explained below.

In FIG. 14, the switch 411 switches the signal for input to the decoder 51 to an output signal of the reverse interleaver 55 (the signal obtained when the exterior value output from the decoder 52 has been reverse-interleaved by the reverse interleaver 55), or to a signal ‘0’. The signal ‘0’ is a log likelihood ‘0’ corresponding to the posterior value [½], and indicates that the priori values (occurrence probabilities) of all the bits are equal.

A switching operation of the switch 411 will be explained. Soft decision data (channel value) as a first demodulation result for a given received signal point is input to a turbo decoder 441, and signal ‘0’ is used as the occurrence probability in a first decoding of this input channel value. The reason for this is that no priori value has been calculated for a received signal point which is being decoded for the first time. Therefore, at the time of the first decoding for a given received signal point, the switch 411 connects the signal ‘0’ to the decoder 51.

In regard to repeated decoding of the input channel value, in second and subsequent demodulations, a signal (priori value) obtained after the exterior value output from the decoder 52 is reverse-interleaved by the reverse interleaver 55 is used as the occurrence probability. Therefore, in second and subsequent demodulations for a given channel value, the switch 411 connects the signal output by the reverse interleaver 55 to the decoder 51.

In the case of identical received signal points, even if the channel value from the 8ASK demodulator 43 is updated, the switch 411 does not return the connection to signal ‘0’. That is, the 8ASK demodulator 43 repeatedly demodulates a given received signal point by using the priori value fed back from the turbo decoder 441, and the channel value is input to the turbo decoder 441 at each demodulation.

At this time, in the case of identical received signal points, signal ‘0’ is used as the occurrence probability only during the first decoding of the channel value of the first demodulation result. For channel values of the second and subsequent demodulation results, from the first decoding, a signal output from the reverse interleaver 55 (a signal {priori value} obtained after the exterior value output from the decoder 52 has been reverse-interleaved by the reverse interleaver 55) is used as the occurrence probability.

According to Example 6 described above, in repeated demodulation and repeated decoding of identical received signal points, occurrence probabilities are made equal only for the first demodulation and the first decoding of the first demodulation; in subsequent demodulations and decodings, an occurrence probability which is fed back from the demodulation process is used as the occurrence probability. Since this continues the repeated demodulating and repeated decoding of the identical received signal points without a break, the demodulation and decoding can be made more precise, and reception performance can be increased.

### EXAMPLE 7

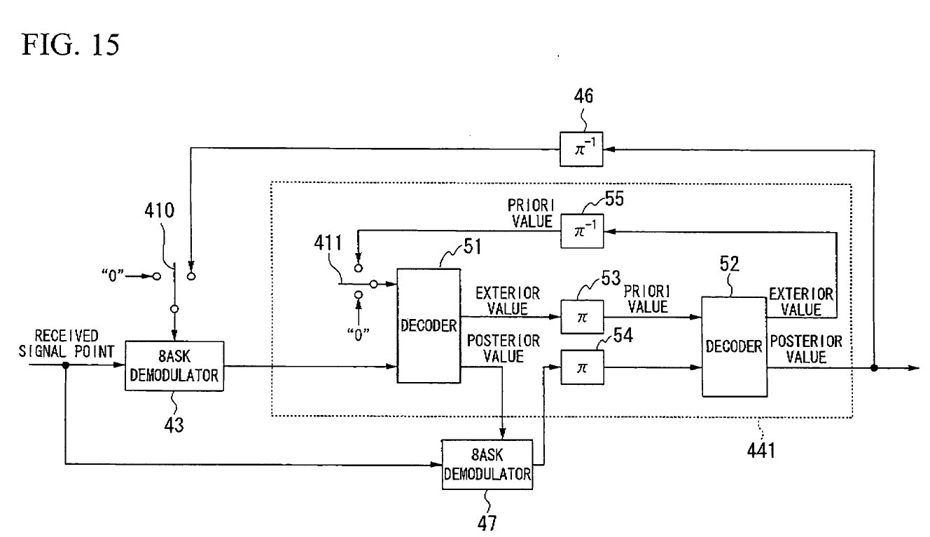

FIG. 15 illustrates a seventh example, and shows a configuration of the turbo decoder 441 and a characteristic configuration of Example 7. Example 7 is a modification of Example 3. As in Example 6, the Example includes the turbo decoder 441, and provides the switch 410 between the reverse interleaver 46 and the 8ASK demodulator 43. The configuration of FIG. 15 differs from that of FIG. 7 in regard to the portion relating to the turbo decoder 441 and the switch 410, the other portions being the same as those in FIG. 7. In FIG. 15, the operations of the switch 410 and the turbo decoder 441 are the same as in Example 6, and are not repetitiously explained.

According to Example 7, as in Example 6, when performing repeated demodulation and repeated decoding of identical received signal points, the occurrence probabilities are made equal only for the first demodulation and the first decoding of the first demodulation; in subsequent demodulations and decodings, an occurrence probability which is fed back from the demodulation process is used as the occurrence probability. Since this continues the repeated demodulating and repeated decoding of the identical received signal points without a break, the demodulation and decoding can be made more precise, and reception performance can be increased.

The turbo antenna 441 can also be substituted in Example 2 shown in FIG. 6, enabling the precision of the repeated decodings to be increased.

### EXAMPLE 8

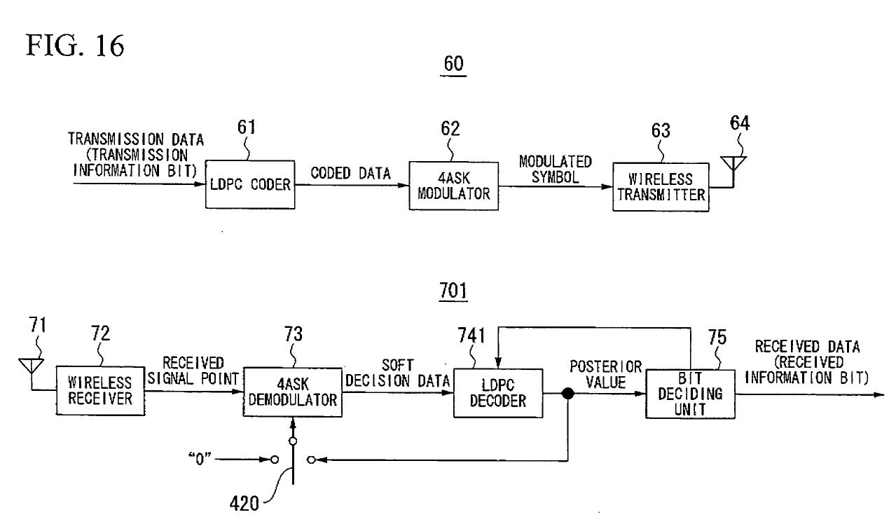

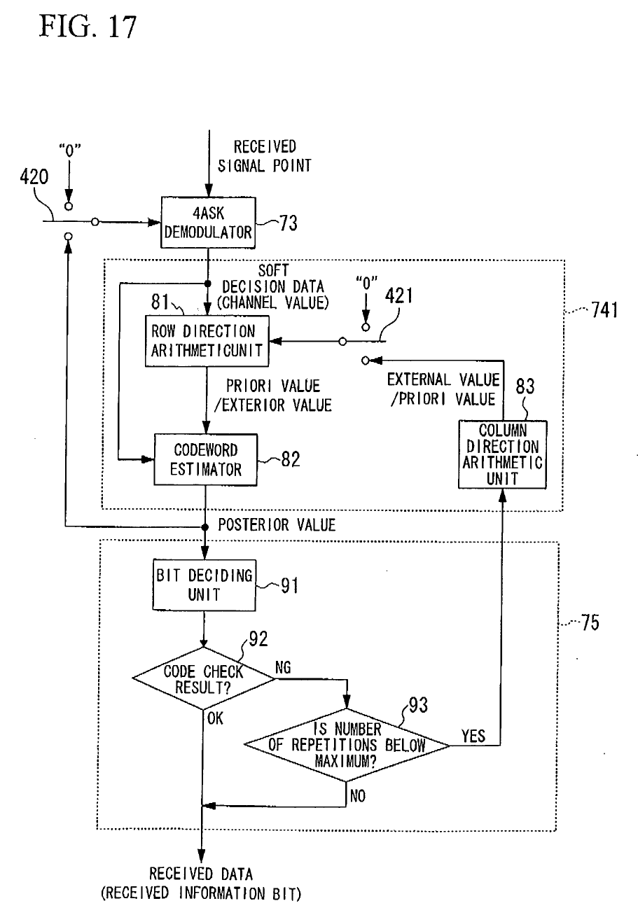

An eighth example is shown in FIG. 16 and FIG. 17.

FIG. 16 is an eighth example of a digital signal transmitting system according to the invention. Example 8 is a modification of Example 5 shown in FIG. 9. Example 8 includes a receiving apparatus 701. The transmitting apparatus 60 is the same as that of Example 5.

The receiving apparatus 701 shown in FIG. 16 includes an LDPC decoder 741. A switch 420 is provided between the output of the LDPC decoder 741 and the input of the 4ASK demodulator 73. The configuration of the receiving apparatus 701 differs from the receiving apparatus 70 of FIG. 9 in regard to the portions relating to the LDPC decoder 741 and the switch 420, other portions being the same as those of the receiving apparatus 70 in FIG. 9. Only the points of difference from the receiving apparatus 70 are explained below.

In FIG. 16, the switch 420 switches a signal for input to the 4ASK demodulator 73 to the output signal (posterior value) of the LDPC decoder 741 or to a signal ‘0’. The signal ‘0’ is a log likelihood ‘0’ corresponding to the posterior value [½], and indicates that the posterior values (occurrence probabilities) of all the bits are equal.

A switching operation of the switch 420 will be explained. A received signal point is input from the wireless receiver 72 to the 8ASK demodulator 73, and signal ‘0’ is used as the occurrence probability in a first demodulation for this input received signal point. The reason for this is that no posterior value has been calculated for a received signal point which is being decoding for the first time. Therefore, at the time of the first demodulation for a given received signal point, the switch 420 connects the signal ‘0’ to the 4ASK demodulator 73.

In second and subsequent decodings of that received signal point, the posterior value output by the LDPC decoder 741 is used as the occurrence probability. Therefore, in second and subsequent demodulations for a given received signal point, the output signal (posterior value) of the LDPC decoder 741 is connected to the 4ASK demodulator

FIG. 17 is a configuration of the LDPC decoder 741 and a characteristic configuration of Example 8. In the LDPC decoder 741 shown in FIG. 17, a switch 421 is provided between the column direction arithmetic unit 83 and the row direction arithmetic unit 81. In the LDPC decoder 741, the point of difference from the LDPC decoder 74 of FIG. 10 is the portion relating to the switch 421, the other parts being the same as the LDPC decoder 74 of FIG. 10. Only the modifications to the LDPC decoder 741 of FIG. 10 will be explained below.

In FIG. 17, the switch 421 switches the signal for input to the row direction arithmetic unit 81 to an output signal of the column direction arithmetic unit 83 (exterior value or priori value) or to a signal ‘0’. The signal ‘0’ is a log likelihood ‘0’ signal that corresponds to the exterior value or the priori value [½], and indicates that the exterior values or the priori values (occurrence probabilities) of all the bits are equal.

A switching operation of the switch 421 will be explained. Soft decision data (channel value) as a first demodulation result for a given received signal point is input to the LDPC decoder 741, and the signal ‘0’ is used as the occurrence probability in a first decoding of this input channel value. The reason for this is that no priori value has been calculated for a received signal point which is being decoded for the first time. Therefore, in the first decoding for a given received signal point, the switch 421 connects the signal ‘0’ to the row direction arithmetic unit 81.

During repeated decodings of the input channel value, in second and subsequent decodings, a signal (priori value) obtained after the exterior value output from the decoder 52 is reverse-interleaved by the reverse interleaver 55 is used as the occurrence probability. Therefore, in second and subsequent decodings of a given channel value, the switch 411 connects the signal which is output by the reverse interleaver 55 to the row direction arithmetic unit 81.

Moreover, in the case of identical received signal points, even if the channel value from the 4ASK demodulator 73 is updated, the switch 411 does not return the connection to signal ‘0’. That is, the 8ASK demodulator 43 repeatedly demodulates a given received signal point by using the posterior value fed back from the LDPC decoder 741, and the channel value is input to the LDPC decoder 741 at each demodulation. At this time, in the case of identical received signal points, signal ‘0’ is used as the occurrence probability only during the first decoding of the channel value of the first demodulation result. For channel values of second and subsequent demodulation results, from the first decoding, a signal output from the column direction arithmetic unit 83 (a signal {exterior value or priori value}) is used as the occurrence probability.

According to Example 8, in repeated demodulating and repeated decoding of identical received signal points, the occurrence probabilities are made equal only for the first demodulation and the first decoding of the first demodulation; in subsequent demodulations and decodings, occurrence probabilities fed back from the demodulation process are used. Since this continues the repeated demodulating and repeated decoding of the identical received signal points without a break, the demodulation and decoding can be made more precise, and reception performance can be increased.

Subsequently, one technical characteristic of the invention will be explained.

As shown in FIGS. 5, 7, 10, 14, 15, 17, and so on, one technical characteristic of the invention is that repeated demodulation is performed while feeding back the prior value (posterior probability) of a decoding result to the demodulator. It is particularly noteworthy that a priori value, not an exterior value, is fed back. The invention concentrates on the fact that better repeated demodulation performance is achieved by using a prior value than an exterior value; therefore, the invention is configured such as to feed back the prior value. The reason for this is explained below.

A transmission symbol x includes two bits (x0 and x1). Let us supposed that the transmission symbol x is transmitted from a transmitting apparatus, and received as a received symbol y by a receiving apparatus. Equation 1 expresses the channel value (likelihood ratio) of bit x0 at this time. The channel value of Equation 1 is usually calculated using the calculation expressed in Equation 2.

$$\begin{matrix}\frac{P ( y \vert {x}_{0} = 0 )}{P ( y \vert {x}_{0} = 1 )} & [ Equation 1 ] \\ \frac{P ( y \vert {x}_{0} = 0 )}{P ( y \vert {x}_{0} = 1 )} = \frac{P ( y \vert {x}_{0} = 0 , {x}_{1} = 0 ) + P ( y \vert {x}_{0} = 0 , {x}_{1} = 1 )}{P ( y \vert {x}_{0} = 1 , {x}_{1} = 0 ) + P ( y \vert {x}_{0} = 1 , {x}_{1} = 1 )} & [ Equation 2 ]\end{matrix}$$

P(y|x0, x1) is the probability that the received symbol is y when the transmission bits are (x0 and x1), and is determined from the received signal point y and reference signal points (x0 and x1). It is assumed that the priori likelihood ratio of bit x1 is 0 (the probability that x1=1 and the probability that x1=0 are both ½).

On the other hand, Equation 3 expresses a calculation method of determining the channel value of Equation 1 from an exterior value Pe(x1) of a demodulator.

$$\frac{P ( y \vert {x}_{0} = 0 )}{P ( y \vert {x}_{0} = 1 )} = \frac{\begin{matrix}P ( y \vert {x}_{0} = 0 , {x}_{1} = 0 ) {P}_{e} ( {x}_{1} = 0 ) + \\ P ( y \vert {x}_{0} = 0 , {x}_{1} = 1 ) {P}_{e} ( {x}_{1} = 1 )\end{matrix}}{\begin{matrix}P ( y \vert {x}_{0} = 1 , {x}_{1} = 0 ) {P}_{e} ( {x}_{1} = 0 ) + \\ P ( y \vert {x}_{0} = 1 , {x}_{1} = 1 ) {P}_{e} ( {x}_{1} = 1 )\end{matrix}} \qquad [ Equation 3 ]$$

In Equation 4, Pp(x1) expresses a posterior probability of a decoder relating to x1, and P(y|x1) expresses a channel value relating to x1.

$${P}_{e} ( {x}_{1} ) = \frac{{P}_{p} ( {x}_{1} )}{P ( y \vert {x}_{1} )} \qquad [ Equation 4 ]$$

Equation 5 is obtained by using Bayes method to modify the channel value of Equation 1.

$$\frac{P ( y \vert {x}_{0} = 0 )}{P ( y \vert {x}_{0} = 1 )} = \frac{P ( {x}_{0} = 0 \vert y )}{P ( {x}_{0} = 1 \vert y )} \cdot \frac{P ( {x}_{0} = 1 )}{P ( {x}_{0} = 0 )} \qquad [ Equation 5 ]$$

Equation 6 is modified by using Bayes method a second time, obtaining Equation 7.

$$\begin{matrix}\frac{P ( {x}_{0} = 0 \vert y )}{P ( {x}_{0} = 1 \vert y )} = \frac{P ( {x}_{0} = 0 , {x}_{1} = 0 \vert y ) + P ( {x}_{0} = 0 , {x}_{1} = 1 \vert y )}{P ( {x}_{0} = 1 , {x}_{1} = 0 \vert y ) + P ( {x}_{0} = 1 , {x}_{1} = 1 \vert y )} & [ Equation 6 ] \\ \frac{P ( {x}_{0} = 0 \vert y )}{P ( {x}_{0} = 1 \vert y )} = \frac{\begin{matrix}\frac{P ( y \vert {x}_{0} = 0 , {x}_{1} = 0 ) P ( {x}_{0} = 0 , {x}_{1} = 0 )}{P ( y )} + \\ \frac{P ( y \vert {x}_{0} = 0 , {x}_{1} = 1 ) P ( {x}_{0} = 0 , {x}_{1} = 1 )}{P ( y )}\end{matrix}}{\begin{matrix}\frac{P ( y \vert {x}_{0} = 1 , {x}_{1} = 0 ) P ( {x}_{0} = 1 , {x}_{1} = 0 )}{P ( y )} + \\ \frac{P ( y \vert {x}_{0} = 1 , {x}_{1} = 1 ) P ( {x}_{0} = 1 , {x}_{1} = 1 )}{P ( y )}\end{matrix}} & [ Equation 7 ]\end{matrix}$$

Since x0 and x1 are generally independent, this establishes Equation 8, obtaining Equation 9.

$$\begin{matrix}P ( {x}_{0} , {x}_{1} ) = P ( {x}_{0} ) P ( {x}_{1} ) & [ Equation 8 ] \\ \begin{matrix}\frac{P ( {x}_{0} = 0 \vert y )}{P ( {x}_{0} = 1 \vert y )} = \frac{\begin{matrix}\frac{P ( y \vert {x}_{0} = 0 , {x}_{1} = 0 ) P ( {x}_{0} = 0 ) P ( {x}_{1} = 0 )}{P ( y )} + \\ \frac{P ( y \vert {x}_{0} = 0 , {x}_{1} = 1 ) P ( {x}_{0} = 0 ) P ( {x}_{1} = 1 )}{P ( y )}\end{matrix}}{\begin{matrix}\frac{P ( y \vert {x}_{0} = 1 , {x}_{1} = 0 ) P ( {x}_{0} = 1 ) P ( {x}_{1} = 0 )}{P ( y )} + \\ \frac{P ( y \vert {x}_{0} = 1 , {x}_{1} = 1 ) P ( {x}_{0} = 1 ) P ( {x}_{1} = 1 )}{P ( y )}\end{matrix}} \\ = \frac{\begin{matrix}P ( y \vert {x}_{0} = 0 , {x}_{1} = 0 ) P ( {x}_{0} = 0 ) P ( {x}_{1} = 0 ) + \\ P ( y \vert {x}_{0} = 0 , {x}_{1} = 1 ) P ( {x}_{0} = 0 ) P ( {x}_{1} = 1 )\end{matrix}}{\begin{matrix}P ( y \vert {x}_{0} = 1 , {x}_{1} = 0 ) P ( {x}_{0} = 1 ) P ( {x}_{1} = 0 ) + \\ P ( y \vert {x}_{0} = 1 , {x}_{1} = 1 ) P ( {x}_{0} = 1 ) P ( {x}_{1} = 1 )\end{matrix}} \\ = \frac{P ( {x}_{0} = 0 )}{P ( {x}_{0} = 1 )} \cdot \frac{\begin{matrix}P ( y \vert {x}_{0} = 0 , {x}_{1} = 0 ) P ( {x}_{1} = 0 ) + \\ P ( y \vert {x}_{0} = 0 , {x}_{1} = 1 ) P ( {x}_{1} = 1 )\end{matrix}}{\begin{matrix}P ( y \vert {x}_{0} = 1 , {x}_{1} = 0 ) P ( {x}_{1} = 0 ) + \\ P ( y \vert {x}_{0} = 1 , {x}_{1} = 1 ) P ( {x}_{1} = 1 )\end{matrix}}\end{matrix} & [ Equation 9 ]\end{matrix}$$

Thus the channel value of Equation 1 can be expressed by Equation 10.

$$\frac{P ( y \vert {x}_{0} = 0 )}{P ( y \vert {x}_{0} = 1 )} = \frac{\begin{matrix}P ( y \vert {x}_{0} = 0 , {x}_{1} = 0 ) P ( {x}_{1} = 0 ) + \\ P ( y \vert {x}_{0} = 0 , {x}_{1} = 1 ) P ( {x}_{1} = 1 )\end{matrix}}{\begin{matrix}P ( y \vert {x}_{0} = 1 , {x}_{1} = 0 ) P ( {x}_{1} = 0 ) + \\ P ( y \vert {x}_{0} = 1 , {x}_{1} = 1 ) P ( {x}_{1} = 1 )\end{matrix}} \qquad [ Equation 10 ]$$

That is, the channel value obtained by a demodulation operation and a priori value (exterior value) obtained by a demodulation operation are different code systems. Therefore, it is preferable to use a posterior value (posterior probability Pp(x1) obtained by the decoder, rather than the priori value (exterior value) obtained by the decoder, as the priori value P(x1) used in repeated demodulation.

As described above, one technical characteristic of the invention obtains an advantageous effect of increasing repeated demodulation performance, by feeding back a posterior value of a decoding result to the demodulator when making repeated demodulations.

While embodiments of the invention have been described with reference to the drawings, the specific configuration is not limited to these embodiments, it being possible to make design modifications and such like without departing from the main points of the invention.

### INDUSTRIAL APPLICABILITY

The present invention is not limited to wireless transmission, and can similarly be applied in a wired system using a communication cable such as an optical fiber cable. Furthermore, a broadcasting system such as a digital broadcasting system can be applied in various types of digital signal transmitting systems.

1. A digital signal transmitting system using digital modulation having two or more bits of information per modulation symbol, the system comprising:
a demodulator that determines a transmitted signal based on a received signal point when the digitally modulated signal is received and an occurrence probability of a modulated symbol of the digital modulation.

2. The digital signal transmitting system according to claim 1, wherein the occurrence probability is based on a reception processing result of the received signal.

3. The digital signal transmitting system according to claim 1, wherein the occurrence probability is based on a likelihood of the reception processing result obtained in a reception process of the received signal.

4. A digital signal transmitting system using digital modulation having two or more bits of information per modulation symbol and a code for transmission, the system comprising:
a demodulator that determines a transmitted signal based on a received signal point when the digitally modulated signal is received and an occurrence probability of a modulated symbol of the digital modulation; and
a decoder that performs a decoding process to the code based on a demodulation result of the demodulator, and feeds back a likelihood of the decoding result obtained in that decoding process as the occurrence probability.

5. A digital signal transmitting system using digital modulation having two or more bits of information per modulation symbol and a code for transmission constituted by a plurality of element codes, the system comprising:
a demodulator that determines a transmitted signal based on a received signal point when the digitally modulated signal is received and an occurrence probability of a modulated symbol of the digital modulation; and
a decoder that includes decoders provided in correspondence with the element codes, the decoder performing a decoding process by inputting a demodulation result of the demodulator to the decoder, and outputting a likelihood of the demodulation result obtained in that decoding process as the occurrence probability.

6. The digital signal transmitting system according to claim 5, wherein a demodulation result of the demodulator reflecting a likelihood of a demodulation result of one of the decoders is used in another of the decoders.

7. The digital signal transmitting system according to claim 5 or 6, wherein the code for transmission is a turbo code, and a priori value, an exterior value, or a value combining both a posterior value and an exterior value, is used as the likelihood of the decoding result.

8. The digital signal transmitting system according to claim 7, further comprising a determining unit that determines the likelihood of a parity bit appended by the element code, from a decoding result corresponding to at least one element code or in a step of obtaining the decoding result; and
an updating unit that updates a channel value using the likelihood of the parity bit.

9. A receiving apparatus that receives a signal modulated by digital modulation having two or more bits of information per modulation symbol, the apparatus comprising:
a demodulator that determines a transmitted signal based on a received signal point when the signal is received and an occurrence probability of a modulated symbol of the digital modulation.

10. The receiving apparatus according to claim 9, wherein the occurrence probability is based on a reception processing result of the received signal.

11. The receiving apparatus according to claim 9, wherein the occurrence probability is based on a likelihood of the reception processing result obtained in a reception process of the received signal.

12. A receiving apparatus that receives a signal that has been subjected to digital modulation having two or more bits of information per modulation symbol, and coding using a code for transmission, the apparatus comprising
a demodulator that determines a transmitted signal based on a received signal point when the digitally modulated signal is received and an occurrence probability of a modulated symbol of the digital modulation; and
a decoder that performs a decoding process to the code based on a demodulation result of the demodulator, and feeds back a likelihood of the decoding result obtained in that decoding process as the occurrence probability.

13. A receiving apparatus that receives a signal that has been subjected to digital modulation having two or more bits of information per modulation symbol, and coding using a code for transmission constituted by a plurality of element codes, the apparatus comprising:
a demodulator that determines a transmitted signal based on a received signal point when the digitally modulated signal is received and an occurrence probability of a modulated symbol of the digital modulation; and
a decoder that includes decoders provided in correspondence with the element codes, the decoder performing a decoding process by inputting a demodulation result of the demodulator to the decoder, and outputs a likelihood of the demodulation result obtained in that decoding process as the occurrence probability.

14. The receiving apparatus according to claim 13, wherein a demodulation result of the demodulator reflecting a likelihood of a demodulation result of one of the decoders is used in another of the decoders.

15. The receiving apparatus according to claim 13 or 14, wherein the code for transmission is a turbo code, and a priori value, an exterior value, or a value combining both a posterior value and an exterior value, is used as the likelihood of the decoding result.

16. The receiving apparatus according to claim 15, further comprising a determining unit that determines the likelihood of a parity bit appended by the element code, from a decoding result corresponding to at least one element code or in a step of obtaining the decoding result; and
an updating unit that updates a channel value.

17. A receiving method of receiving a signal modulated by digital modulation having two or more bits of information per modulation symbol, the method comprising:
determining a transmitted signal based on a received signal point when the signal is received and an occurrence probability of a modulated symbol of the digital modulation.

18. The receiving method according to claim 17, wherein the occurrence probability is based on a reception processing result of the received signal.

19. The receiving method according to claim 17, wherein the occurrence probability is based on a likelihood of the reception processing result obtained in a reception process of the received signal.

20. A receiving method of receiving a signal that has been subjected to digital modulation having two or more bits of information per modulation symbol, and coding using a code for transmission, the method comprising:
a demodulating step of determining a transmitted signal based on a received signal point when the digitally modulated signal is received and an occurrence probability of a modulated symbol of the digital modulation; and
a decoding step of performing a decoding process to the code based on a demodulation result of the demodulator, and feeding backs a likelihood of the decoding result obtained in that decoding process as the occurrence probability.

21. A receiving method receiving a signal that has been subjected to digital modulation having two or more bits of information per modulation symbol, and coding using a code for transmission constituted by a plurality of element codes, the method comprising:
a demodulating step of determining a transmitted signal based on a received signal point when the digitally modulated signal is received and an occurrence probability of a modulated symbol of the digital modulation; and
a decoding step of performing a decoding process in correspondence with the element codes, performing the decoding process using a demodulation result of the demodulating step, and outputting a likelihood of the demodulation result obtained in that decoding process as the occurrence probability.

22. The receiving method according to claim 21, wherein a demodulation result of the demodulating step reflecting a likelihood of a demodulation result of one of the decoding processes is used in another of the decoding processes.

23. The receiving method according to claim 21 or 22, wherein the code for transmission is a turbo code, and a priori value, an exterior value, or a value combining both a posterior value and an exterior value, is used as the likelihood of the decoding result.

24. The receiving method according to claim 23, further comprising a step of determining the likelihood of a parity bit appended by the element code, from a decoding result corresponding to at least one element code or in a step of obtaining the decoding result; and
a step of updating a channel value by using the likelihood of the parity bit.

25. A digital signal transmitting system using digital modulation having two or more bits of information per modulation symbol and a code for transmission, the system comprising:
a demodulator that determines a transmitted signal based on a received signal point when the signal is received and an occurrence probability of a modulated symbol of the digital modulation; and
a decoder that performs a decoding process to the code based on a demodulation result of the demodulator, and feeds backs a posterior value as the occurrence probability.

26. A digital signal transmitting system using digital modulation having two or more bits of information per modulation symbol and a code for transmission, the system comprising:
a demodulator that determines a transmitted signal based on a received signal point when the signal is received and an occurrence probability of a modulated symbol of the digital modulation; and
a decoder that performs a decoding process to the code based on a demodulation result of the demodulator, and feeds backs a likelihood of a decoding result obtained in that decoding process as the occurrence probability;
the demodulator that deems that occurrence probabilities of all bits are equal at the time of a first demodulation of the received signal point, and using an occurrence probability that is fed back from the decoder at the time of second and subsequent demodulations of the same received signal point.

27. A digital signal transmitting system using digital modulation having two or more bits of information per modulation symbol and a code for transmission, the system comprising:
a demodulator that determines a transmitted signal based on a received signal point when the signal is received and an occurrence probability of a modulated symbol of the digital modulation; and
a decoder that performs a decoding process to the code based on a demodulation result of the demodulator, and feeds back a likelihood of a decoding result obtained in that decoding process as the occurrence probability;
the decoder deeming that occurrence probabilities of all bits are equal at the time of a first demodulation of the received signal point, and using a likelihood of a bit obtained in a decoding process at the time of subsequent demodulations and decodings of the same received signal point as the occurrence probability.

28. The digital signal transmitting system according to claim 27 or 28, wherein an occurrence probability fed back to the demodulator from the decoder is a posterior value.

29. A receiving apparatus that receives a signal that has been subjected to digital modulation having two or more bits of information per modulation symbol, and coding using a code for transmission, the apparatus comprising:
a demodulator that determines a transmitted signal based on a received signal point when the signal is received and an occurrence probability of a modulated symbol of the digital modulation; and
a decoder that performs a decoding process of the code from the demodulation result of the demodulator, and feeds back a posterior value as the occurrence probability.

30. A receiving apparatus that receives a signal that has been subjected to digital modulation having two or more bits of information per modulation symbol, and coding using a code for transmission, the apparatus comprising:
a demodulator that determines a transmitted signal based on a received signal point when the signal is received and an occurrence probability of a modulated symbol of the digital modulation; and
a decoder that performs a decoding process to the code based on a demodulation result of the demodulator, and feeds backs a likelihood of a decoding result obtained in that decoding process as the occurrence probability;
the demodulator deeming that occurrence probabilities of all bits are equal at the time of a first demodulation of the received signal point, and using an occurrence probability that is fed back from the decoder at the time of second and subsequent demodulations of the same received signal point.

31. A receiving apparatus that receives a signal that has been subjected to digital modulation having two or more bits of information per modulation symbol, and coding using a code for transmission that allows repeated decoding, the apparatus comprising:
a demodulator that determines a transmitted signal based on a received signal point when the signal is received and an occurrence probability of a modulated symbol of the digital modulation; and
a decoder that performs a decoding process to the code based on a demodulation result of the demodulator, and feeds back a likelihood of a decoding result obtained in that decoding process as the occurrence probability;
the demodulator deeming that occurrence probabilities of all bits are equal at the time of a first demodulation of the received signal point, and using a bit likelihood, which is obtained in a decoding process in subsequent demodulations and decodings of the same received signal point, as an occurrence probability.

32. The receiving apparatus according to claim 30 or 31, wherein the occurrence probability fed back from the a decoder to the demodulator is a posterior value.

33. A receiving method of receiving a signal that has been subjected to digital modulation having two or more bits of information per modulation symbol, and coding using a code for transmission, the method comprising:
a demodulating step of determining a transmitted signal based on a received signal point when the signal is received and an occurrence probability of a modulated symbol of the digital modulation; and
a decoding step of performing a decoding process of the code from the demodulation result of the demodulator, and feeding back a posterior value as the occurrence probability.

34. A receiving method of receiving a signal that has been subjected to digital modulation having two or more bits of information per modulation symbol, and coding using a code for transmission, the method comprising:
a demodulating step of determining a transmitted signal based on a received signal point when the signal is received and an occurrence probability of a modulated symbol of the digital modulation; and
a decoding step of performing a decoding process to the code based on a demodulation result of the demodulator, and feeding back a likelihood of a decoding result obtained in that decoding process as the occurrence probability;
the demodulating step deeming that occurrence probabilities of all bits are equal at the time of a first demodulation of the received signal point, and using an occurrence probability that is fed back from the decoding means at the time of second and subsequent demodulations of the same received signal point.

35. A receiving method of receiving a signal that has been subjected to digital modulation having two or more bits of information per modulation symbol, and coding using a code for transmission that allows repeated decoding, the method comprising:
a demodulating step of determining a transmitted signal based on a received signal point when the signal is received and an occurrence probability of a modulated symbol of the digital modulation; and
a decoding step of performing a decoding process to the code based on a demodulation result of the demodulator, and feeding back a likelihood of a decoding result obtained in that decoding process as the occurrence probability;
the demodulating step deeming that occurrence probabilities of all bits are equal at the time of a first demodulation of the received signal point, and using a bit likelihood, which is obtained in a decoding process in subsequent demodulations and decodings of the same received signal point, as an occurrence probability.

36. The receiving method according to claim 34 or 35, wherein the occurrence probability fed back from the decoding step to the demodulating step is a posterior value.
